(19) United States
(12) Patent Application Publication
(10) Pub. No.: US 2020/0383522 A1
(43) Pub. Date: Dec. 10, 2020

(54) COOKING APPLIANCE AND CONTROL METHOD THEREOF

(71) Applicant: FOSHAN SHUNDE MIDEA ELECTRICAL HEATING APPLIANCES MANUFACTURING CO., LTD., Foshan (CN)

(72) Inventors: Yi ZHOU, Foshan (CN); Junfeng DU, Foshan (CN); Guozhu LI, Foshan (CN); Jingwen LI, Foshan (CN); Fuyou LI, Foshan (CN); Jiaying ZHANG, Foshan (CN); Peng CHEN, Foshan (CN); Xiong LIAO, Foshan (CN); Hao ZHENG, Foshan (CN)

(21) Appl. No.: 16/763,007

(22) PCT Filed: Aug. 8, 2018
(86) PCT No.: PCT/CN2018/099361

§ 371 Date: May 11, 2020

(30) Foreign Application Priority Data
Feb. 9, 2018 (CN) 201810140145.X
Feb. 9, 2018 (CN) 201820243533.6
Apr. 16, 2018 (CN) 201820540233.4

(51) Int. Cl. A47J 36/32; F24C 15/00; F24C 7/08; G01G 19/414; G01G 19/52

(52) U.S. Cl. CPC A47J 36/32; F24C 15/00; G01G 19/52; G01G 19/4146; F24C 7/082

(57) ABSTRACT

A control method of a cooking appliance includes acquiring a current weight of a container of the cooking appliance with a food material through a weighing device of the cooking appliance, calculating a weight of the food material in the container according to the current weight of the container with the food material and an initial weight of the container without the food material, and determining a calorie amount of the food material according to the weight of the food material and a type of the food material.

### TECHNICAL FIELD

The present disclosure relates to the technical field of electrical appliances, in particular to a control method of a cooking appliance and a cooking appliance using the control method.

### BACKGROUND

With the development of living quality, people are increasingly focusing on the importance of health. Unhealthy eating habits as the major contributors to diseases such as obesity, hypertension, and diabetes, are typically embodied as unable to control the calories intake during an eating course, and may lead to over-nutrition or under-nutrition. Up to now, there exists no cooking appliance that can measure the calories of food material, and help users understand the calories of food and guide them to adjust the amount of food intake catering to their own needs.

### SUMMARY

The main purpose of the present disclosure is to provide a control method for cooking appliance, which can measure the calories of food material, thus guiding users to adjust the intake quantity of food material according to their own needs. In order to achieve the above object, the present disclosure provides a control method of a cooking appliance which includes a weighing device and a container for a food material and water, and the control method includes: acquiring, through the weighing device, a current weight of the container with the food material; calculating a weight of the food material in the container, according to the current weight of the container with the food material and an initial weight of the container without the food material, and displaying the weight of the food material; determining a first calorie amount of the food material according to the weight of the food material and a type of the food material, and displaying the first calorie amount of the food material.

Preferably, the operation of determining a first calorie amount of the food material according to the weight of the food material and a type of the food material, includes: inquiring a preset table according to the type of the food material to obtain a calorie value corresponding to a unit weight of the food material; and calculating the first calorie amount, according to the calorie value corresponding to the unit weight of the food material, and the weight of the food material.

Preferably, after the operations of calculating a weight of the food material in the container, according to the current weight of the container with the food material and an initial weight of the container without the food material, and displaying the weight of the food material, the control method further includes: acquiring a cooking function set by a user; acquiring a target water addition amount according to the weight of food material in the container, the cooking function and the type of the food material; acquiring, through the weighing device, a current weight of the container with the food material and the water; prompting the user for water addition, according to the current weight of the container with food material and water, and the target water addition amount.

Preferably, the operation of acquiring a target water addition amount according to the weight of food material in the container, the cooking function and the type of the food material, further includes: inquiring a preset table according to the cooking function to obtain a first ratio of a unit weight of the food material to a weight of water; inquiring the preset table according to the type of the food material to obtain a second ratio of a unit weight of the food material to a weight of water; calculating the target water addition amount according to the weight of the food material, the first ratio, and the second ratio.

Preferably, the operation of prompting the user for water addition, according to the current weight of the container with the food material and the water, and the target water addition amount, further includes: determining whether a difference between the current weight of the container with the food material and the water and a sum of the initial weight of the container, the weight of the food material and a weight of the target water addition amount is within a preset range; prompting the user that the water addition amount is appropriate, if the difference is within the preset range; prompting the user to continue water addition, if the difference is out of the preset range.

Preferably, after the operation of prompting the user for water addition, according to the current weight of the container with the food material and the water, and the target water addition amount, the control method further includes: estimating a second calorie amount of the food material after cooked, according to the weight of the food material, the type of the food material and the cooking function, and displaying the second calorie amount.

Preferably, the operation of estimating a second calorie amount of the food material after cooked, according to the weight of the food material, the type of the food material and the cooking function, and displaying the second calorie amount, further includes: inquiring a preset table according to the type of the food material and the cooking function, to obtain a calorie value corresponding to a unit weight of the food material after cooked; and calculating the second calorie amount of the food material after cooked, according to the weight of the food material, the target water addition amount and the calorie value corresponding to the unit weight of the food material after cooked.

Preferably, after the operation of estimating a second calorie amount of the food material after cooked, according to the weight of the food material, the type of the food material and the cooking function, and displaying the second calorie amount, the control method further includes: determining whether the second calorie amount of the food material after cooked is greater than a preset threshold value; prompting the user to readjust the weight of the food material, if the second calorie amount is greater than the preset threshold value; prompting the user that a food calorie amount meets a requirement, if the second calorie amount is not greater than the preset threshold value.

Preferably, after the operation of prompting the user that a food calorie amount meets a requirement, the control method further includes: recording the second calorie amount of the food material and sending the second calorie amount to a smart terminal.

Preferably, after the operation of estimating a second calorie amount of the food material after cooked, according to the weight of the food material, the type of the food material and the cooking function, and displaying the second calorie amount, the control method further includes: acquiring, through the weighing device, a weight of the food material that is taken out after cooked; determining a third calorie amount of the food material that is taken out after cooked, according to the weight of the food material that is taken out after cooked and the type of the food material that is taken out after cooked.

The present disclosure further provides a control method of the cooking appliance, which includes a weighing device and a container for a food material and water, and the control method includes: acquiring, through the weighing device, a current weight of the container with the food material; calculating a weight of the food material in the container, according to the current weight of the container with the food material and an initial weight of the container without the food material, and displaying the weight of the food material; acquiring a cooking function set by a user; acquiring a target water addition amount according to the weight of the food material in the container, the cooking function and the type of the food material; acquiring, through the weighing device, a current weight of the container with the food material and the water; prompting the user for water addition, according to the current weight of the container with the food material and the water, and the target water addition amount; estimating a calorie amount of the food material after cooked, according to the weight of the food material, the type of the food material and the cooking function, and displaying the second calorie amount; determining whether the calorie amount of the food material after cooked is greater than a preset threshold value; prompting the user to readjust the weight of the food material, if the second calorie amount is greater than the preset threshold value; prompting the user that a food calorie amount meets a requirement, if the second calorie amount is not greater than the preset threshold value.

The present disclosure further provides a cooking appliance, which comprises a container for containing food material and water; a weighing device for weighing the current weight of the container with food material and/or water; a control panel comprising a key selecting unit and a display unit, wherein the key selecting unit is used for selecting types of food material; and a signal processor for calculating the weight of the food material in the container according to the current weight of the container with the food material and the initial weight of the container obtained through the weighing device, determining the calories of the food material according to the weight of the food material and the type of the food material, and displaying the calories of the food material.

Preferably, the key selecting unit is further configured to acquire a cooking function set by a user; the signal processor is further configured to acquire a target water addition amount according to the weight of food material in the container, the cooking function and the type of the food material, and control the display unit to display the target water addition amount.

Preferably, the cooking appliance further includes a first prompter electrically connected with the signal processor, and the signal processor is further configured to prompt the user for water addition according to an actual water addition amount and the target water addition amount.

Preferably, the signal processor is further configured to estimate a second calorie amount of the food material after cooked, according to the weight of the food material, the type of the food material and the cooking function, and control the display unit to display the second calorie amount.

Preferably, the cooking appliance further includes a second prompter electrically connected with the signal processor, the signal processor being further configured to determine a calorie amount of the food material to be greater than a preset threshold value; control the second prompter to prompt the user to readjust the weight of food material, if the second calorie amount is greater than the preset threshold value; control the second prompter to prompt the user that a food calorie amount meets a requirement, if the second calorie amount is not greater than the preset threshold value.

Preferably, the signal processor is further configured to: acquire, through a weighing device, a weight of the food material that is taken out after cooked, and determine a third calorie amount of the food material that is taken out after cooked, according to the weight of the food material that is taken out after cooked and the type of the food material, and display the third calorie amount of the food material.

Preferably, the weighing device includes a weight sensor to sense a weight of the cooking appliance; and a control module electrically connected with the weight sensor, in which the control module comprises a display unit and an acquisition unit electrically connected with the weight sensor and the display unit.

Preferably, the cooking appliance includes: a cooker body, in which the cooker body further includes a base assembly on which the weight sensor is disposed; the control module is disposed on the cooker body and spaced apart from the weight sensor.

Preferably, the cooker body is further includes a face cover assembly, and a housing assembly connected with the base assembly and the face cover assembly, in which the acquisition unit is disposed on the base assembly, and the display unit is disposed on the housing assembly or the face cover assembly.

According to the control method of the cooking appliance provided by the embodiments of the present disclosure, calories are calculated on food material placed in the cooking appliance, so that the user can be helped to know the intake calories of the food material, adjust the food consumption of the food material according to own needs. Specifically, the control method of the cooking appliance includes the following operations: first, acquiring, through the weighing device, a current weight of the container with the food material; then calculating a weight of the food material in the container, according to the current weight of the container with the food material and an initial weight of the container without the food material, and displaying the weight of the food material; finally determining a first calorie amount of the food material according to the weight of the food material and a type of the food material, and displaying the first calorie amount of the food material. As the control method provided by the present disclosure can calculate the calories of the food material after the food material has been added into the container, i.e. the calorie value of the food material after cooked can be estimated when the food material is still raw, it can guide a user to adjust the intake amount of the food material according to own needs, and ensure that the calories of the food material after cooked can meet the expectation of the user, thereby helping the user intake a rational amount of energy and further maintain the dietary health.

### BRIEF DESCRIPTION OF THE DRAWINGS

FIG. 1 is a flowchart of a control method of a cooking appliance according to an embodiment of the present disclosure;

FIG. 2 is a flowchart of a control method of a cooking appliance according to another embodiment of the present disclosure;

FIG. 3 is a flowchart of a control method of a cooking appliance according to some other embodiment of the present disclosure;

FIG. 4 is a flow chart of using the cooking appliance according to the present disclosure;

FIG. 5 is a functional block diagram of the cooking appliance according to an embodiment of the present disclosure;

FIG. 6 is a functional block diagram of the cooking appliance according to another embodiment of the present disclosure;

FIG. 7 is a schematic structural top view of the cooking appliance according to the present disclosure;

FIG. 8 is a schematic perspective view of the cooking appliance according to the present disclosure;

FIG. 9 is a top plan view of an optional cooking appliance according to the present disclosure;

FIG. 10 is a schematic bottom plan view of an optional cooking appliance according to the present disclosure;

FIG. 11 is a schematic structural view of an optional base assembly of the cooking appliance according to the present disclosure;

FIG. 12 is a side view of an optional cooking appliance according to the present disclosure.

The implementation, functional features and advantages of the present application will be further described with reference to the accompanying drawings with the embodiments.

### DETAILED DESCRIPTION OF THE EMBODIMENTS

Hereinafter, embodiments of the present disclosure will be described in detail, examples of which are illustrated in the accompanying drawings. The same or similar reference numerals refer to the same or similar elements or elements having the same or similar functions throughout the specification. The embodiments described below by referring to the accompanying drawings are exemplary and are intended to explain the present disclosure, and should not be construed as a limitation to the present disclosure.

Below a control method of a cooking appliance according to an embodiment of the present disclosure and a cooking appliance using the control method will be described with reference to the accompanying drawings.

First, a control method of a cooking appliance according to an embodiment of the present disclosure will be described. The cooking appliance includes a weighing device and a container for containing food material and water. For example, the cooking appliance may be, but is not limited to, an electric rice cooker, an electric pressure cooker, etc.

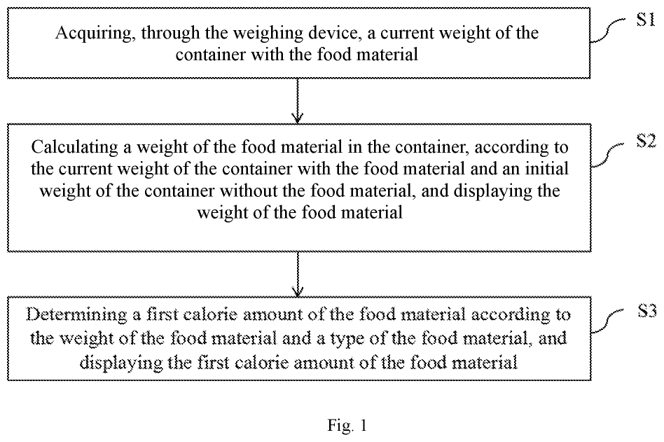

FIG. 1 is a flowchart of a control method of a cooking appliance according to one embodiment of the present disclosure. As shown in FIG. 1, the control method includes the following operations.

S1, acquiring, through the weighing device, a current weight of the container with the food material.

It should be appreciated that the initial weight of the container is set when the cooking appliance leaves the factory. Take an electric cooker as an example, the initial weight of a container can be considered as the weight of an empty inner pot. After the user puts food material such as rice into the inner pot, the function is started of measuring the weight of rice, and the current weight of the container, i.e., the total weight that is a sum of the initial weight of the inner pot and the weight of the placed rice, is measured through the weighing device at a preset time interval such as 10 milliseconds. The preset time interval can be adjusted adaptively according to different requirements.

S2, calculating a weight of the food material in the container, according to the current weight of the container with the food material and an initial weight of the container without the food material, and displaying the weight of the food material.

Specifically, the weight of food material placed in the container is the difference between the current weight of the container and the initial weight of the container. When the weight of the food material in the container is determined, the weight of the food material can further be displayed, so that the user can conveniently check the weight of the food material in the process of adding the food material.

S3, determining a first calorie amount of the food material according to the weight of the food material and a type of the food material, and displaying the first calorie amount of the food material.

Specifically, the operation of determining a first calorie amount of the food material according to the weight of the food material and a type of the food material, includes: inquiring a preset table according to the type of the food material to obtain a calorie value corresponding to a unit weight of the food material; and calculating the first calorie amount, according to the calorie value corresponding to the unit weight of the food material, and the weight of the food material.

Taking rice as an example, the above operations will now be described in detail. The user adds raw rice into the container. The preset table is then inquired according to the type of raw rice, such as black rice, to obtain the calorie value corresponding to black rice of a unit weight. Further, the first calorie amount of the black rice is calculated according to the weight of the black rice and the calorie value corresponding to the unit weight of the black rice.

It should be appreciated that in the present embodiment, the first calorie amount is calculated according to the weight of uncooked black rice. However, the calorie values of the raw black rice and the cooked black rice are not exactly the same. Therefore in other embodiments, the first calorie amount can further be calculated according to the cooked rice. Specifically, under different cooking functions, such as the rice cooking function, the amount of the black rice added corresponds to the amount of the cooked rice. The calorie value of the uncooked black rice can be determined through the corresponding ratio of the raw rice to the cooked rice after experimentally measuring the calorie value of the cooked rice for many times. And the calorie value of the uncooked black rice calculated through the cooked rice has higher accuracy than that of the uncooked rice.

As the control method provided by the present disclosure can calculate the calories of the food material after the food material has been added into the container, i.e. the calorie value of the food material after cooked can be estimated when the food material is still raw, it can guide a user to adjust the intake amount of the food material according to own needs, and ensure that the calories of the food material after cooked can meet the expectation of the user, thereby helping the user intake a rational amount of energy and further maintain the dietary health.

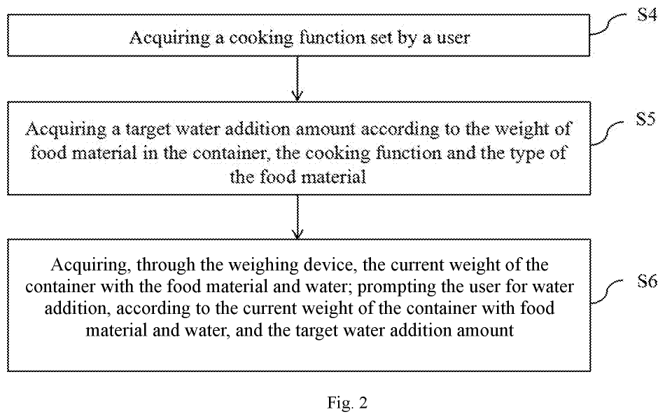

Further, referring to FIG. 2, in order to make the amount of water added by the user more accurate, after the operations of calculating a weight of the food material in the container, according to the current weight of the container with the food material and an initial weight of the container without the food material, and displaying the weight of the food material, the control method further includes:

S4, acquiring a cooking function set by a user.

The cooking functions include rice cooking, congee cooking, porridge cooking, etc. Due to different cooking functions and different water addition ratios, the first operation in controlling the water addition amount is to obtain the cooking function set by the user.

S5, acquiring a target water addition amount according to the weight of food material in the container, the cooking function and the type of the food material.

Specifically, first, a preset table is inquired according to the cooking function to obtain a first ratio of the unit weight of the food material and the weight of the water, and the water adding ratio varies in cooking functions. In short, the first ratio of rice cooking is larger than the first ratio of porridge cooking, namely, rice with a same weight would consume or use less water for cooking than that for porridge cooking. Then, a preset table is inquired according to the types of the food material to obtain a second ratio of unit food material weight and water weight. The cooking properties of different food material are different. That is, glutinous rice is more tolerant to cooking, and may consume a larger amount of water, compared to cooking the white rice with a same weight. White rice with the same weight uses less water than glutinous rice, and the second ratio of white rice is larger than the second ratio of glutinous rice. Finally, the target water addition amount is calculated according to the weight of the food material, the first ratio and the second ratio. Taking white rice cooking as an example, the weight of white rice is known, the first ratio can be determined according to the cooking function, the second ratio can be determined according to the type of white rice, and then the target water consumption required for white rice cooking can be finally determined.

S6, acquiring, through the weighing device, the current weight of the container with the food material and water; prompting the user for water addition, according to the current weight of the container with food material and water, and the target water addition amount.

Specifically, it is judged whether a difference between the current weight of the container with the food material and the water and a sum of the initial weight of the container, the weight of the food material, and a weight of the target water addition amount is within a preset range. In other words, it is determined whether the absolute value of the difference between the actual amount of water addition and the target water addition amount is less than a certain preset threshold value, and if yes, it is suggested to the user that the amount of water added is appropriate; and if not, it is indicated to the user to continue to adjust the amount of water addition.

It should be appreciated that in the present embodiment, it is not simply to compare whether the actual water addition amount is equal to the target water addition amount, but to judge whether the actual water addition amount is close to the target water addition amount. Therefore, as long as the actual water addition amount is close to the target water addition amount, no matter if the actual water addition amount is less than the target water addition amount or greater than the target water addition amount, the user would be prompted that the water addition amount is appropriate, thus facilitating the control of the water addition.

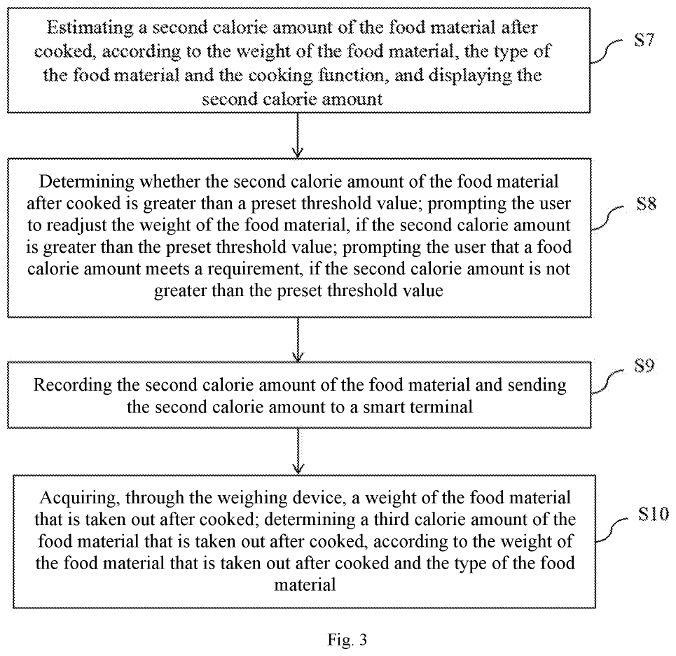

Further, please refer to FIG. 3. In the second embodiment of the present disclosure, considering that food material with the same weight have different calorie energies after different cooking functions, the present embodiment calculates the calories of food material with food material after cooked. Specifically, the calories contained in the cooked rice is different from that of the cooked porridge with a same weight. In order to improve the accuracy of food material calorie calculation, after the operation of prompting the user for water addition, according to the current weight of the container with the food material and the water, and the target water addition amount, the control method further includes:

S7, estimating a second calorie amount of the food material after cooked, according to the weight of the food material, the type of the food material and the cooking function, and displaying the second calorie amount.

Specifically, the operation of estimating a second calorie amount of the food material after cooked, according to the weight of the food material, the type of the food material and the cooking function, and displaying the second calorie amount, includes:

First, the preset table is inquired according to the type of the food material and the cooking function, and a calorie value is obtained corresponding to a unit weight of the food material after cooked; and

Then the second calorie amount of the food material after cooked is calculated, according to the weight of the food material, the target water addition amount and the calorie value corresponding to the unit weight of the food material after cooked.

Since the cooking function is taken into account when calculating the calorie values of the food material in the present embodiment, the calorie value of the food material can be calculated according to the total weight of the food material and water, as well as the calorie value in unit weight of the food material after cooked. The calorie value is calculated according to the food material after cooked, therefore, the calorie value has higher accuracy.

Further, in order to enable the user to adjust the weight of the food according to his own needs, after the operation of estimating a second calorie amount of the food material after cooked, according to the weight of the food material, the type of the food material and the cooking function, and displaying the second calorie amount, the control method further includes:

S8, determining whether the second calorie amount of the food material after cooked is greater than a preset threshold value; prompting the user to readjust the weight of the food material, if the second calorie amount is greater than the preset threshold value; prompting the user that a food calorie amount meets a requirement, if the second calorie amount is not greater than the preset threshold value.

As the user can know the calories of the food before cooking the food, and can adjust the weight of the food according to the actual needs and change the intake of the food, the present disclosure can ensure that the calories of the cooked food can meet the expectation of the user, thereby helping the user to maintain a healthy diet.

Further, in order to help users better understand their own eating habits, the control method further includes, after prompting that the calorie amount of the food meets the requirements:

S9, recording the second calorie amount of the food material and sending the second calorie amount to a smart terminal. The smart terminal can record the calorie amount taken by the user for each meal, thereby helping the user to better understand his/her eating habits.

Further, in the third embodiment of the present disclosure, considering that the weight of water is reduced during cooking of food material, in order to make the calculation of food material calorie more accurate, after the operations of estimating a second calorie amount of the food material after cooked, according to the weight of the food material, the type of the food material and the cooking function, and displaying the second calorie amount, the control method further includes:

S10, acquiring, through the weighing device, a weight of the food material that is taken out after cooked; determining a third calorie amount of the food material that is taken out after cooked, according to the weight of the food material that is taken out after cooked and the type of the food material.

As the third calorie amount is calculated based on the weight of food material after cooked, taking rice cooking as an example, the calorie value of unit weight of the cooked rice can be measured through experiments. And the calorie value of the rice taken out can be accurately calculated according to the calorie value per unit weight of rice and the weight of the rice taken out, thus helping the user to accurately know the calories of the rice during the out-taking process of the rice, and further to intake an appropriate calorie amount and maintain healthy eating habits.

It should be appreciated that the first embodiment of the present disclosure estimates the first calorie amount of food material after cooked by the weight of raw food material, which is convenient to operate for adjusting the weight of raw food material. However, without considering cooking function, there will be certain errors in the estimation of food calories. According to the second embodiment of the disclosure, the cooking function is taken into consideration, and the second calorie amount of food material after cooked is estimated according to the weight of raw food material, the weight of water and the calories per unit weight of food material after cooked. Operation is convenient, the weight of raw food material can be adjusted promptly, and the calories estimation is more accurate. According to the third embodiment of the present disclosure, the calories of food material after cooked is calculated by the weight of the food material after cooked, and the calories calculation is rather accurate. These three embodiments aforementioned are perceived with different technical concepts, and can be freely combined with each other. For example, after the second embodiment and the third embodiment are combined, the weight of the food material can be adjusted in time while the food material is raw, so that the calories of the food material after cooked can just meet the needs of the user, and the calories of the extracted food material can be accurately calculated according to the weight of the food material taken out by the user after the food material is cooked, thereby guiding the user to diet reasonably.

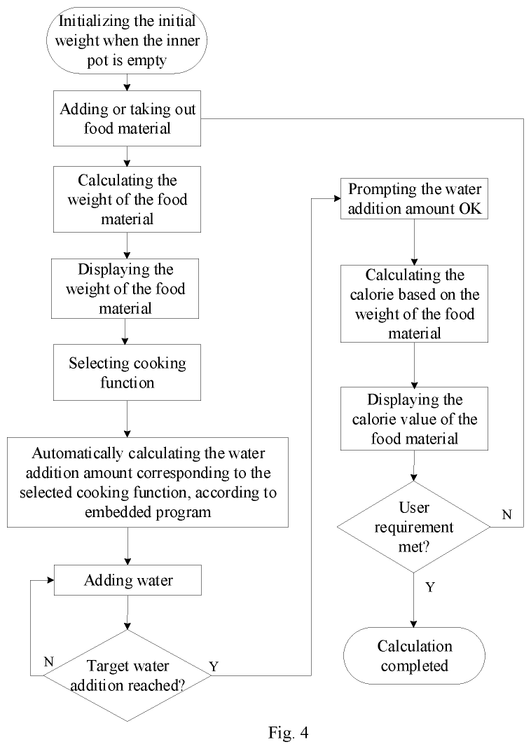

FIG. 4 is a flowchart of a control method of a cooking appliance according to the present disclosure, which specifically includes:

initializing the initial weight when the inner pot is empty;

adding or taking out the food material;

calculating the weight of the food material:

acquiring, through the weighing device, a current weight of the container with the food material; then calculating a weight of the food material in the container, according to the current weight of the container with the food material and an initial weight of the container without the food material, and displaying the weight of the food material;

acquiring a cooking function set by a user;

acquiring a target water addition amount according to the weight of food material in the container, the cooking function and the type of the food material;

acquiring, through the weighing device, a current weight of the container with the food material and the water;

prompting the user for water addition, according to the current weight of the container with food material and water, and the target water addition amount; prompting the user that the water addition amount is appropriate, if the difference is within the preset range; prompting the user to continue water addition, if the difference is out of the preset range;

estimating the calorie amount of the food material after cooked, according to the weight of the food material, the type of the food material and the cooking function, and displaying the calorie amount. Specifically, the primary principle of operation regarding estimating the calorie amount of the food material after cooked, according to the weight of the food material, the type of the food material and the cooking function, and displaying the calorie amount, is the same as the second embodiment, which will not be repeated herein.

It is determined whether the second calorie amount of the food material after cooked meets the requirements of a user. If yes, the measurement of the food material is completed and the food material is cooked according to the current weight of the food material, so that the calorie value of the finally food material after cooked can meet the requirements of the user; if not, the user needs to add more of or take out some of the food material from the inner pot until the weight of the food material can meet the user's requirements.

It should be appreciated that when the calorie value is greater than the preset threshold, it does not meet the user's requirements, the user would be prompted to readjust the weight of food material. When the calorie value is less than or equal to the preset threshold, meaning it satisfying the user's requirements and the user would be prompted that the calorie value of food material meets the requirements.

However, the concept of the present disclosure is not limited as aforementioned. In some other embodiments, the user's need may further be that the calorie value of the food material be greater than or equal to the preset threshold value, thus helping the user to gain weight. Thus, when the calorie value is greater than or equal to the preset threshold value, the user's requirement is met, and the user is prompted that the calorie value of the food material meets the requirement; while when the calorie value is less than the preset threshold value, indicating the requirement of the user being not met, and the user is prompted to readjust the food weight. In other words, the value of the preset threshold and the judgment standard can be adjusted adaptively according to the needs of different users.

In order to implement the aforementioned embodiments, the present disclosure further provides a cooking appliance.

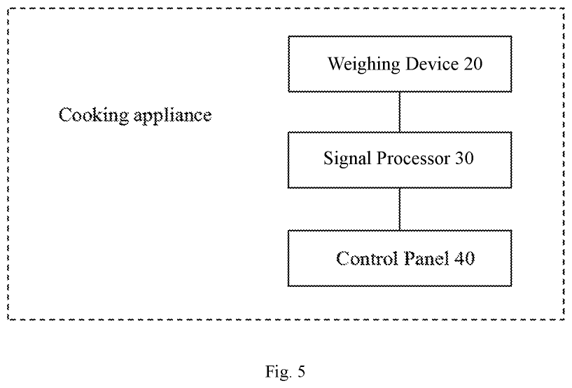

FIG. 5 is a functional block diagram of a cooking appliance according to one embodiment of the present disclosure. As shown in FIG. 5, the cooking appliance includes a container 10, a weighing device 20, a signal processor 30, and a control panel 40.

The container 10 is configured to contain food material and/or water, and the weighing device 20 is configured to weigh the current weight of the container 10 with the food material and/or water and converting external gravity into an electrical signal. The control panel 40 includes a selecting unit to select a cooking function and the type of the food material, as well as a display unit for displaying information such as food material weight, water addition amount, calorie amount, etc. The signal processor 30 is configured to calculate a weight of the food material in the container 10 according to the current weight of the container 10 with the food material and an initial weight of the container without the food material, and to determine a first calorie amount of the food material according to the weight of the food material and the type of the food material, and display the first calorie amount of the food material by the display unit.

Specifically, the cooking appliance may include, for example, an electric rice cooker or an electric pressure cooker. Take an electric rice cooker as an example, as shown in FIGS. 5 to 8, the container 10, i.e. the inner pot, is configured to contain the rice and the water. The electric rice cooker includes a housing, an inner pot and a weighing device 20. The inner pot is disposed in the housing, and the weighing device 20 is disposed at the bottom of the housing.

Described as follows is the working process of the electric cooker according to some embodiment of the present disclosure. First, the weighing device 20 acquires a current weight of the container 10 with the food material; then the signal processor calculates a weight of the food material in the container 10, according to the current weight of the container 10 with the food material and an initial weight of the container 10 without the food material, and displaying the weight of the food material; finally the signal processor 30 determines a first calorie amount of the food material according to the weight of the food material and a type of the food material, and displays the first calorie amount of the food material.

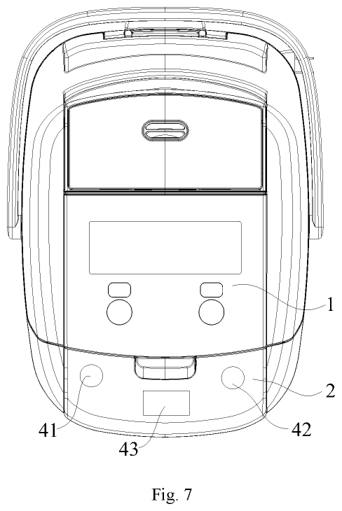

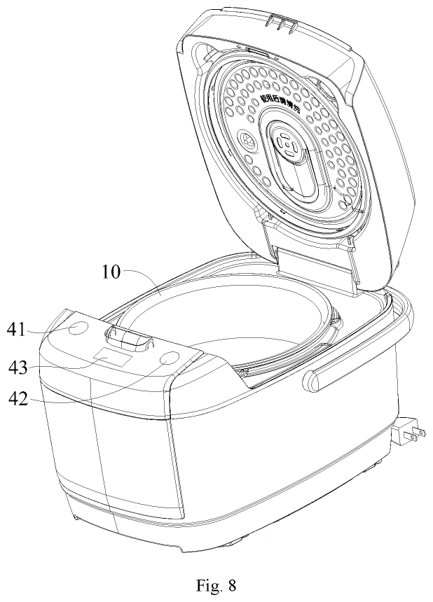

Preferably, please refer to FIGS. 7 to 8. The electric cooker provided by the present disclosure includes a first control panel 1 and a second control panel 2. The first control panel 1 is disposed on the pot cover, while the second control panel 2 is disposed on the pot body. The second control panel 2 includes the main control panel 30 and the control panel 40. The control panel 40 is provided with a weighing key 41, a calorie calculation key 42 and a display area 43. The first control panel 1 is provided with some conventional cooking function keys and a function di splay area.

The present disclosure additionally provides a second control panel 2 in addition to the first control panel 1. The first control panel 1 is configured to control the conventional cooking function of the electric cooker, while the second control panel 2 is configured to control the weighing function and the calories calculation function of the electric cooker. The two control panels respectively control different functions, thus improving the using convenience.

Specifically, the second control panel 2 is disposed on the top of the housing of the pot body, so when the pot cover is opened to add food or water, the second control panel 2 does not turn to the back side together with the pot cover. When the lid of the cooking appliance is open, the user can conveniently control the second control panel 2. The weighing device can still be controlled by the second control panel 2 to detect the weight of the food material in the container 10 and display the weight information of the food material, thereby facilitating the user to use the weighing function of the electric cooker. And similarly, when the pot cover is opened to add food or water, the calories calculation function can further be conveniently controlled by the second control panel 2.

Additionally, in order to calculate the corresponding water addition amount according to the weight of food material, so as to facilitate the user to add water, in one embodiment of the present disclosure, the key selecting unit is further configured to acquire a cooking function set by a user; the signal processor is further configured to acquire a target water addition amount according to the weight of food material in the container, the cooking function and the type of the food material, and display the target water addition amount by the display unit. Since the display unit can display the target water addition amount, and prompt the user for water addition, the user can obtain accurate water addition amount under different cooking functions. Specifically, the display unit may be an LED display screen or the like.

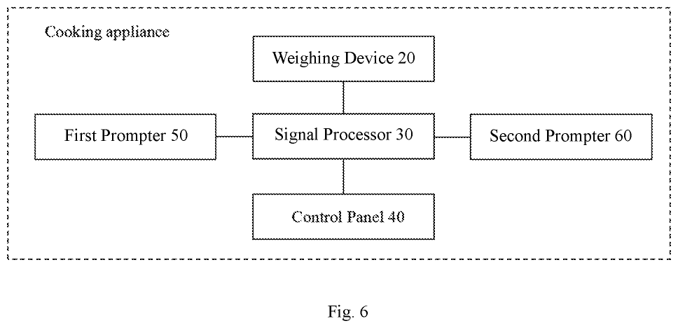

Further, as shown in FIG. 6, in order to make the amount of water added by the user more accurate, the cooking appliance further includes a first prompter 50, and the signal processor 30 is further configured to control the first prompter 50 to prompt that the amount of water added is appropriate when the difference between the current weight of the container 10 with food and water and the sum of the initial weight of the container 10, the weight of the food and the weight of the target amount of water added is within a preset range; otherwise, the first prompter 50 is controlled to prompt the continuous adjustment of the water addition amount.

Additionally, in order to improve the accuracy of calorie calculation in the food material, in an embodiment of the present disclosure, the signal processor 30 is further configured to estimate a calorie amount of the food material after cooked, according to the weight of the food material, the type of the food material and the cooking function, and control the display unit to display the calorie amount. As the present embodiment not only considers the types of food material, but further considers the influence of cooking function on the calories of food material after cooked, so that the accuracy of the calories calculation result of food material can be improved. The detailed principle can be seen in the description of the second embodiment of the control method of the cooking appliance.

Further, in order to improve the accuracy of calorie calculation of the food material, the signal processor 30 is further configured to acquire, through a weighing device, a weight of the food material that is taken out after cooked, and determine a calorie amount of the food material that is taken out after cooked, according to the weight of the food material that is taken out after cooked and the type of the food material, and display the calorie amount of the food material. Since the present embodiment measures the weight of food material after cooked, it has higher accuracy when calculating calorie by using the weight of food material. The detailed principle can be seen in the description of the third embodiment of the control method of the cooking appliance.

Further, as shown in FIG. 6, in order to prompt a user to adjust the weight of food according to his own needs, the cooking appliance further includes a second prompter 60, and the signal processor 30 is further configured to: when the calories is greater than a preset threshold, the signal processor 30 controls the second prompter 60 to issue an alarm prompter; when the calories is less than or equal to a preset threshold, the signal processor 30 records the calories of the food material. It should be appreciated that the calories can be calculated in three scenarios. In the first scenario the first calorie amount is calculated according to the weight of raw food material and the type of raw food material; in the second scenario, the type of food cooked, such as rice or porridge, is estimated according to the weight of raw food material, the type of raw food material and the cooking function, before estimating the second calorie amount by the calorie value of unit weight of the food material after cooked, the weight of raw food material and the weight of added water; in the third scenario, the third calorie amount of the cooked food is directly calculated according to the weight of the cooked food taken out of the container and the calorie value of unit weight of the cooked food. The specific implementation mode can refer to the first to third embodiments of the control method of the cooking appliance. It should be appreciated that the second prompter and the first prompter are buzzers, light prompters, etc.

Further, in order to help users better understand their own eating habits, the cooking appliance further includes a communication circuit for sending the calorie values of the food recorded by the signal processor 30 to a smart terminal.

It should be appreciated that in this document, the terms “comprising” “including” or any other variation thereof are intended to cover a non-exclusive inclusion, such that a process, method, article, or system that includes a list of elements includes not only those elements but also other elements not expressly listed, or elements inherent to such process, method, article, or system. Without further restrictions, an element defined by the statement “includes an” does not exclude the presence of another identical element in a process, method, article, or system including the element.

The aforementioned serial numbers regarding the embodiments of the present application are for description only and do not represent the superiority and inferiority of the embodiments.

From the above description of the embodiments, those skilled in the art can clearly understand that the method of the above embodiments can be implemented by means of software plus necessary general-purpose hardware platforms. Of course, it can also be implemented by means of hardware, but in many cases the former is a better embodiment. Based on this understanding, the technical solution of the present application can be embodied in the form of a software product, which is stored in a storage medium (such as ROM/RAM, magnetic disk, optical disk) as described above, and includes several instructions to cause a terminal device (which can be a mobile phone, a computer, a server, an air conditioner, or a network device, etc.) to perform the methods described in various embodiments of the present application.

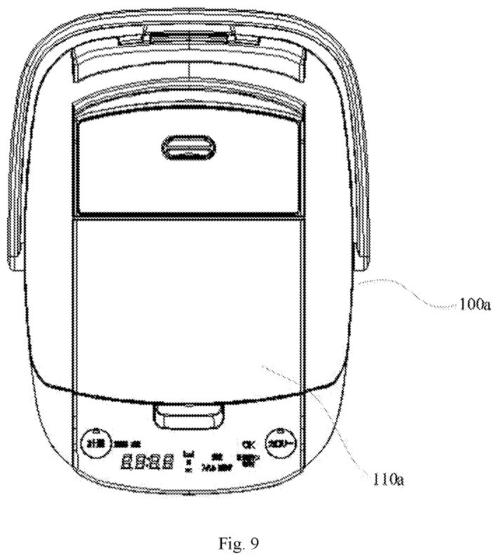

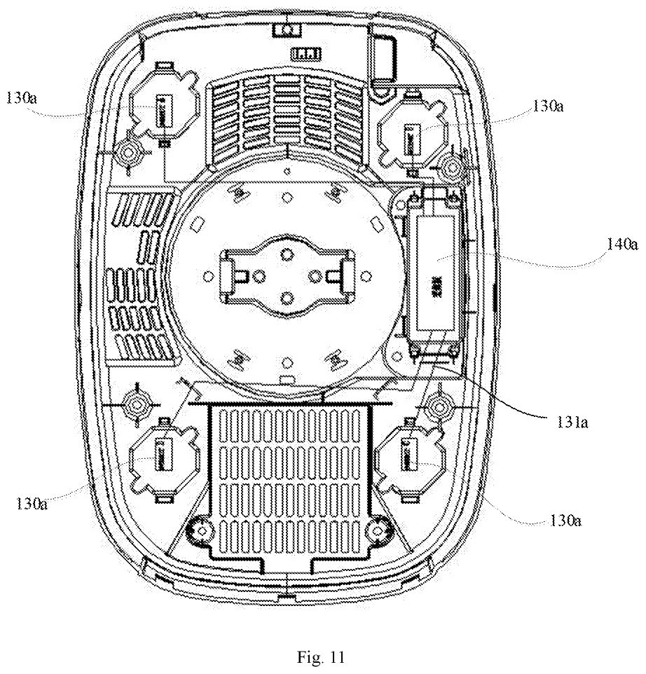

The weighing device of the cooking appliance of the present disclosure will now be described in detail. As shown in FIGS. 9 to 12, the weighing device 20 includes a weight sensor 130a configured to sense the weight of a cooking appliance, a control module electrically connected to the weight sensor 130a. The control module includes an acquisition unit 140a and a display unit 150a. The acquisition unit 140a is electrically connected to the weight sensor 130a and the display unit 150a.

Since the weight sensor 130a senses the weight of the cooking appliance instead of the weight of the inner container of the cooking appliance, the weight sensor 130a may not be disposed inside the cooking appliance, thus improving the manufacturability of the cooking appliance. The weight sensed by the weight sensor 130a includes the weight of the cooking appliance and the weight of the food material added to the inner container of the cooking appliance. The cooking appliance of the embodiment of the present disclosure includes but are not limited to electric cookers, electric pressure cookers, steam cookers and other kitchen appliance.

In an optional embodiment of the present disclosure, the weight sensor 130a is electrically connected to the acquisition unit 140a through a first set of wires 131a.

The acquisition unit 140a and the display unit 150a may be integral or separated. In a preferred embodiment of the present disclosure, the acquisition unit 140a and the display unit 150a are separately disposed with an interval. Setting the control module as split structures including the acquisition unit 140a and the display unit 150a, enables to realize modular installation of the weight sensor 130a, the acquisition unit 140a and the display unit 150a before a general assembly, facilitates quality inspection before and after the general assembly, and improves the manufacturability of cooking appliance.

In another optional embodiment of the present disclosure, the acquisition unit 140a is electrically connected to the display unit 150a through a second set of wires 141a. The weight sensor 130a may be one or several (i.e., more than one). When a plurality of weight sensors 130a are disposed on the base assembly 120a, each weight sensor 130a is electrically connected with the acquisition unit 140a through a first set of wires 131a, and the acquisition unit 140a is electrically connected with the display unit 150a through a second set of wires 141a. This reduces the number of times for wire insertion, and wiring difficulty.

The embodiment of the second aspect of the present application provides a cooking appliance, which includes a weighing device described in the above embodiment of the cooker body 100. The cooker body 100a is provided with a base assembly 120a, and a weight sensor 130a is provided on the base assembly 120a. The control module is disposed on the cooker body 100a and spaced apart from the weight sensor 130a.

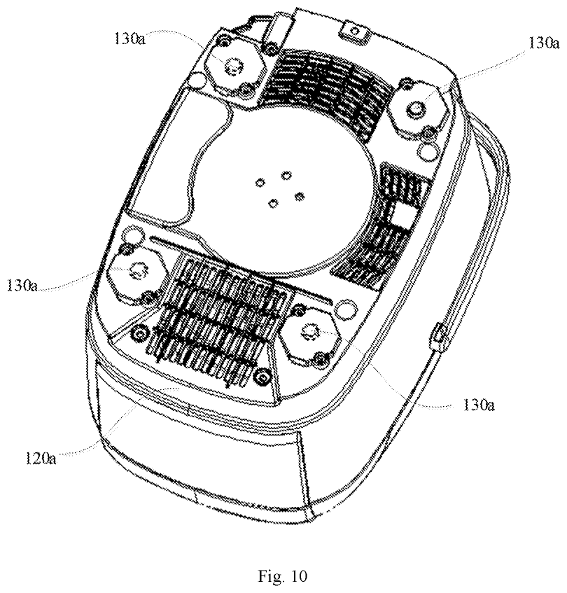

FIGS. 9 and 10 exemplarily show structural schematic views of an electric rice cooker. A weight sensor 130a is disposed on a base assembly 120a of the electric rice cooker, and the weight sensor 130a is exposed at least partially outside the electric rice cooker to contact a supporting surface such as a desktop. When the electric cooker is placed on the desktop, the weight sensor 130a senses weight information, and the weight information is sent to the display unit 150a through the acquisition unit 140a, and then the first weight value is displayed to the user. The user presses the reset button on the electric cooker to reset the first weight value, and then add food material into the electric cooker. As such, the second weight value displayed by the display unit 150a is the weight of the food material.

In an optional embodiment of the present disclosure, the base assembly 120a is provided with a plurality of weight sensors 130a, and each weight sensor 130a is electrically connected with the acquisition unit 140a. The number of the plurality of weight sensors 130a is preferably more than three, which can ensure that the base assembly 120a is on the same horizontal plane with the cooker body 100a not inclined, thus ensuring the accuracy of weight measurement. Each of the plurality of weight sensors 130a is separately connected with the acquisition unit 140a, and then the acquisition unit 140a is connected with the display unit 150a. The information can be transmitted by only one connection, and each weight sensor 130a does not need to be separately in communication with the display unit 150a, thus improving the assembly efficiency.

In a preferred embodiment of the present application, four weight sensors 130a are disposed on the base assembly 120a, respectively on the four legs of the base assembly 120a. FIG. 3 exemplarily shows a schematic structural diagram of a base assembly 120a of an electric rice cooker, with four legs of the base assembly 120a are respectively provided with a weight sensor 130a. Each weight sensor 130a is electrically connected with an acquisition unit 140a through a first set of wires 131a, and the acquisition unit 140a is electrically connected with a display unit 150a through a second set of wires 141a. The information can be transmitted by only one connection.

According to another optional embodiment of the present disclosure, the cooker body 100a is further provided with a housing assembly 160a and a face cover assembly 110a. The housing assembly 160a is connected with the base assembly 120a and the face cover assembly 110a. The acquisition unit 140a is disposed on the base assembly 120a, and the display unit 150a is disposed on the housing assembly 160a or the face cover assembly 110a.

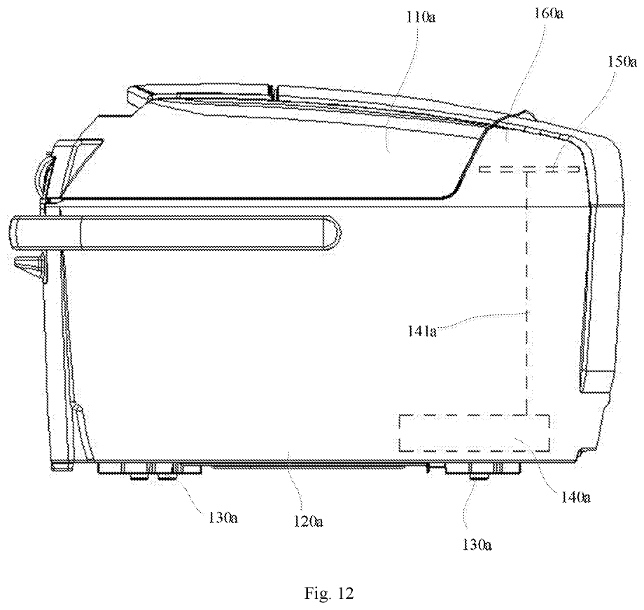

FIG. 12 exemplarily shows a side view of an optional structure of an electric cooker. The acquisition unit 140a is mounted the base assembly 120a and in communication with the weight sensor 130a, to form a first component assembly. The display unit 150a is mounted at the housing assembly 160a, and the display unit 150a and the housing cover form a second component assembly. This connection does not require each weight sensor 130a to separately wire and communicate with the display unit 150a, thus reducing the number of plug wires and the wiring difficulty and improving the assembly efficiency. Additionally, the acquisition unit 140a and the display unit 150a are in communication with wires, so that the information can be transmitted by only one connection. The cross-part communication failure rate is reduced between the first part assembly and the second part assembly.

In real products, the bottom of the cooking appliance is typically provided with protruding legs to support the cooker body 100a. When a plurality of weight sensors 130a are disposed on the base assembly 120a, according to an optional embodiment of the present disclosure, each weight sensor 130a protrudes at least partially downward from the base assembly 120a. The part of the weight sensor protruding downward from the base assembly 120a can support the cooker body 100a, and further, the weight sensor 130a serves as a supporting leg. No additional supporting leg is required on the base assembly 120a.

The above are only the preferred embodiments of the present application and does not limit the scope of the present application thereto. Any equivalent structure or process change made by using the contents of the present specification and drawings, or directly or indirectly applied in other related technical fields, shall be included in the protection scope of the present application.

1.-20. (canceled)

21. A control method of a cooking appliance comprising:
acquiring, through a weighing device of the cooking appliance, a current weight of a container of the cooking appliance with a food material;
calculating a weight of the food material in the container according to the current weight of the container with the food material and an initial weight of the container without the food material; and
determining a calorie amount of the food material according to the weight of the food material and a type of the food material.

22. The control method of claim 21, wherein determining the calorie amount of the food material according to the weight of the food material and the type of the food material includes:
inquiring a preset table according to the type of the food material to obtain a unit calorie value corresponding to a unit weight of the food material; and
calculating the calorie amount according to the unit calorie value and the weight of the food material.

23. The control method of claim 21,
wherein the current weight of the container with the food material is a first current weight of the container;
the method further comprising, after calculating the weight of the food material:
acquiring a cooking function;
acquiring a target water addition amount according to the weight of the food material, the cooking function, and the type of the food material;
acquiring, through the weighing device, a second current weight of the container with the food material and water; and
prompting for water addition according to the second current weight of the container and the target water addition amount.

24. The control method of claim 23, wherein acquiring the target water addition amount includes:
inquiring a preset table according to the cooking function to obtain a first ratio of a unit weight of the food material to a weight of water;
inquiring the preset table according to the type of the food material to obtain a second ratio of the unit weight of the food material to the weight of water; and
calculating the target water addition amount according to the weight of the food material, the first ratio, and the second ratio.

25. The control method of claim 23, wherein prompting for water addition includes:
judging whether a difference between the second current weight of the container and a sum of the initial weight of the container, the weight of the food material, and a weight of the target water addition amount is within a preset range;
in response to the difference being within the preset range, prompting that a current water addition amount is appropriate; and
in response to the difference not being within the preset range, prompting to continue to add water.

26. The control method of claim 23,
wherein the calorie amount is a first calorie amount of the food material;
the method further comprising, after prompting for water addition:
estimating a second calorie amount of the food material after cooked according to the weight of the food material, the type of the food material, and the cooking function.

27. The control method of claim 26, wherein estimating the second calorie amount includes:
inquiring a preset table according to the type of the food material and the cooking function to obtain a calorie value corresponding to a unit weight of the food material after cooked; and
calculating the second calorie amount according to the weight of the food material, the target water addition amount, and the calorie value corresponding to the unit weight of the food material after cooked.

28. The control method of claim 26, further comprising, after estimating the second calorie amount:
judging whether the second calorie amount of the food material after cooked is greater than a preset threshold value;
in response to the second calorie amount being greater than the preset threshold value, prompting to readjust the weight of the food material; and
in response to the second calorie amount not being greater than the preset threshold value, prompting that a food calorie amount meets a requirement.

29. The control method of claim 28, further comprising, after prompting that the food calorie amount meets the requirement:
recording the second calorie amount of the food material and sending the second calorie amount to a smart terminal.

30. The control method of claim 26, further comprising, after estimating the second calorie amount:
acquiring, through the weighing device, a weight of the food material that is taken out after cooked; and
determining a third calorie amount of the food material that is taken out after cooked according to the weight of the food material that is taken out after cooked and the type of the food material taken out after cooked.

31. A control method of a cooking appliance comprising:
acquiring, through a weighing device of the cooking appliance, a first current weight of a container of the cooking appliance with a food material;
calculating a weight of the food material in the container according to the first current weight and an initial weight of the container without the food material;
acquiring a cooking function;
acquiring a target water addition amount according to the weight of the food material in the container, the cooking function, and a type of the food material;
acquiring, through the weighing device, a second current weight of the container with the food material and water;
prompting for water addition according to the second current weight and the target water addition amount;
estimating a calorie amount of the food material after cooked according to the weight of the food material, the type of the food material, and the cooking function;
judging whether the calorie amount of the food material after cooked is greater than a preset threshold value;
in response to the calorie amount being greater than the preset threshold value, prompting to readjust the weight of the food material; and
in response to the calorie amount not being greater than the preset threshold value, prompting that a food calorie amount meets a requirement.

32. A cooking appliance comprising:
a container configured to contain a food material and water;
a weighing device configured to weigh a current weight of the container with the food material;
a control panel including a key selecting unit configured to receive a selection of a type of the food material; and
a signal processor configured to:
calculate a weight of the food material in the container according to the current weight of the container with the food material and an initial weight of the container without the food material; and
determine a calorie amount of the food material according to the weight of the food material and the type of the food material.

33. The cooking appliance of claim 32, wherein:
the control panel further includes a display;
the key selecting unit is further configured to acquire a cooking function; and
the signal processor is further configured to:
acquire a target water addition amount according to the weight of food material, the cooking function, and the type of the food material, and
control the display to display the target water addition amount.

34. The cooking appliance of claim 33, further comprising:
a prompter electrically connected with the signal processor;
wherein the signal processor is further configured to prompt for water addition according to an actual water addition amount and the target water addition amount.

35. The cooking appliance of claim 33, wherein:
the calorie amount is a first calorie amount of the food material; and
the signal processor is further configured to:
estimate a second calorie amount of the food material after cooked according to the weight of the food material, the type of the food material, and the cooking function; and
control the display to display the second calorie amount.

36. The cooking appliance of claim 33, wherein:
the calorie amount is a first calorie amount of the food material; and
the signal processor is further configured to:
acquire, through the weighing device, a weight of the food material that is taken out after cooked, and
determine a second calorie amount of the food material that is taken out after cooked according to the weight of the food material that is taken out after cooked and the type of the food material taken out after cooked; and
control the display to display the second calorie amount.

37. The cooking appliance of claim 32, further comprising:
a prompter electrically connected with the signal processor;
wherein the signal processor is further configured to:
judge whether the calorie amount of the food material is greater than a preset threshold value;
in response to the calorie amount being greater than the preset threshold value, control the prompter to prompt to readjust the weight of food material; and
in response to the calorie amount not being greater than the preset threshold value, control the prompter to prompt that a food calorie amount meets a requirement, if the second calorie amount is not greater than the preset threshold value.

38. The cooking appliance of claim 32, wherein the weighing device includes:
a weight sensor configured to sense a weight of the cooking appliance; and
a controller electrically connected with the weight sensor and including a display unit and an acquisition unit electrically connected with the weight sensor and the display unit.

39. The cooking appliance of claim 38, further comprising:
a cooker body including a base assembly;
wherein:
the weight sensor is disposed at the base assembly; and
the control module is disposed at the cooker body and spaced apart from the weight sensor.

40. The cooking appliance of claim 39, wherein
the cooker body further includes:
a face cover assembly; and
a housing assembly connected with the base assembly and the face cover assembly; and
the acquisition unit is disposed at the base assembly, and the display unit is disposed at the housing assembly or the face cover assembly.
